(19) United States
(12) Patent Application Publication
(10) Pub. No.: US 2023/0085136 A1
(43) Pub. Date: Mar. 16, 2023

(54) BEAM COMBINING MODULE AND BEAM SCANNING PROJECTOR SYSTEM

(71) Applicant: Sharp Fukuyama Laser Co., Ltd., Fukuyama City (JP)

(72) Inventors: PETER JOHN ROBERTS, Oxford (GB); NATHAN COLE, Oxford (GB); Valerie Busque, Oxford (GB); Noriaki FUJII, Fukuyama City (JP); KATSUSHIGE MASUI, Fukuyama City (JP)

(21) Appl. No.: 17/942,074

(22) Filed: Sep. 9, 2022

(30) Foreign Application Priority Data
Sep. 14, 2021 (JP) 2021-149620

(51) Int. Cl. G02B 27/10; G02B 27/14; G02B 27/12

(52) U.S. Cl. CPC G02B 27/1006; G02B 27/141; G02B 27/123

(57) ABSTRACT

A beam combining module combines a first beam corresponding to a first wavelength and a second beam corresponding to a second wavelength. The beam combining module includes a collimating lens, a first mirror, and second mirror. The collimating lens is configured to receive the first beam and the second beam that are parallel to each other and to emit the first beam and the second beam in respective non-parallel directions. The first mirror is configured to reflect the first beam emitted by the collimating lens. The second mirror is configured to reflect the second beam emitted by the collimating lens in a direction parallel to the first beam reflected by the first mirror and in such a manner that the second beam emitted by the collimating lens spatially overlaps the first beam reflected by the first mirror.

### CROSS-REFERENCE TO RELATED APPLICATION

The present application claims priority from Japanese Patent Application Number 2021-149620, the content to which is hereby incorporated by reference into this application.

### BACKGROUND OF THE INVENTION

### 1. Field of the Invention

The present invention, in an aspect thereof, relates to beam combining modules and beam scanning projector systems for combining laser beams of different wavelengths.

### 2. Description of the Related Art

Beam combining modules for combining laser beams of different wavelengths have been known as conventional art (Chinese Utility Model No. 206848675 and Japanese Unexamined Patent Application Publication, Tokukai, No. 2011-197217).

Chinese Utility Model No. 206848675 describes a beam combining module including: three light sources emitting red, green, and blue light respectively; three collimating lenses for collimating the red, green, and blue light emitted by the three light sources respectively; and a dichroic combining prism for combining the red, green, and blue light collimated by the three collimating lenses.

Japanese Unexamined Patent Application Publication, Tokukai, No. 2011-197217 describes a beam combining module including: a dichroic block including first to third dichroic mirrors; a first collimating lens and a first light source facing the first dichroic mirror; a second collimating lens and a second light source facing the second dichroic mirror; and a third collimating lens and a third light source facing the third dichroic mirror.

An incident beam that has travelled from the first light source via the first collimating lens passes through the first and second dichroic mirrors, reflects off the third dichroic mirror, and refracts at the output interface of the dichroic block upon exiting. An incident beam that has travelled from the second light source via the second collimating lens reflects off the second and third dichroic mirrors and refracts at the output interface of the dichroic block upon exiting. An incident beam that has travelled from the third light source via the third collimating lens passes through the third dichroic mirror and refracts at the output interface of the dichroic block upon exiting.

The beam combining modules described in Chinese Utility Model No. 206848675 and Japanese Unexamined Patent Application Publication, Tokukai, No. 2011-197217 use separate collimating lenses to collimate the beam from each light source. This is advantageous in adjusting parallel light of individual beams and producing parallel, but non-overlapping beams. These beams are later combined using a mirror that is a combination of a plurality of dichroic mirrors.

However, these beam combining modules described in Chinese Utility Model No. 206848675 and Japanese Unexamined Patent Application Publication, Tokukai, No. 2011-197217 require a separate collimating lens for the beam from each light source, which undesirably adds to the size of the beam combining modules.

The present invention, in an aspect thereof, has an object to provide a beam combining module and a beam scanning projector system with a reduced size.

### SUMMARY OF THE INVENTION

To accomplish the object, the present invention, in one aspect thereof, is directed to a beam combining module that combines a first beam corresponding to a first wavelength and a second beam corresponding to a second wavelength, the beam combining module including: a collimating lens configured to receive the first beam and the second beam that are parallel to each other and to emit the first beam and the second beam in respective non-parallel directions; a first mirror configured to reflect the first beam emitted by the collimating lens; and a second mirror configured to reflect the second beam emitted by the collimating lens in a direction parallel to the first beam reflected by the first mirror and in such a manner that the second beam emitted by the collimating lens spatially overlaps the first beam reflected by the first mirror.

To accomplish the object, the present invention, in one aspect thereof, is directed to a beam combining module that combines a first beam corresponding to a first wavelength and a second beam corresponding to a second wavelength, the beam combining module including: a first mirror configured to transmit the second beam and to reflect the first beam; a second mirror disposed parallel to the first mirror and configured to reflect the second beam transmitted by the first mirror; and a collimating lens configured to receive the first beam reflected by the first mirror and the second beam reflected by the second mirror and to emit the first beam and the second beam in such directions that the first beam and the second beam travel parallel to, and spatially overlap, each other.

To accomplish the object, the present invention, in one aspect thereof, is directed to a beam scanning projector system including the beam combining module of an aspect of the present invention.

The present invention, in an aspect thereof, can reduce the size of the beam combining module and the beam scanning projector system.

### BRIEF DESCRIPTION OF THE DRAWINGS

FIG. 1 is a front view of a beam combining module in accordance with Embodiment 1.

FIG. 2 is a side view of the beam combining module.

FIG. 3 is a front view of a beam combining module in accordance with Embodiment 2.

FIG. 4 is a front view of a beam combining module in accordance with Embodiment 3.

FIG. 5 is a front view of a beam combining module in accordance with Embodiment 4.

FIG. 6 is a front view of a beam combining module in accordance with Embodiment 5.

FIG. 7 is a perspective view of a beam combining module in accordance with Embodiment 6.

FIG. 8 is a front view of a beam combining module in accordance with Embodiment 7.

### DETAILED DESCRIPTION OF THE INVENTION

Embodiments 1 to 7 relate to the improvement of beam combining modules for combining RGB laser beams emitted by laser diodes. In all Embodiments 1 to 7, a single common collimating lens is used for collimating all the beams to be combined. The use of a single collimating lens makes it difficult to make optical adjustments for parallelism of the beams and for combining waves in the direction of the optical axis of the beam. Therefore, no prior art technology has been discovered that involves use of a single collimating lens for combining all the beams.

Chip positioning technology by methods such as “pick and place” has been rapidly developed in recent years. This is used in micro-LED display devices. It is now possible to position and wire laser diode chips with micron accuracy. That has in turn made it possible to manufacture an ultra-compact beam combining module with a single collimating lens.

The precise positioning of the laser diode chip by the use of “pick and place” described above is beneficial to the present embodiment. Using active alignment, the parallelism of beams and the direction of the optical axis of the beam can be combined by adjusting optical components while the beams emitted by the beam combining modules are being monitored. For active alignment, the laser diode chips of course need to be wired and emit light before precise adjustment is attempted for combining waves.

### Embodiment 1

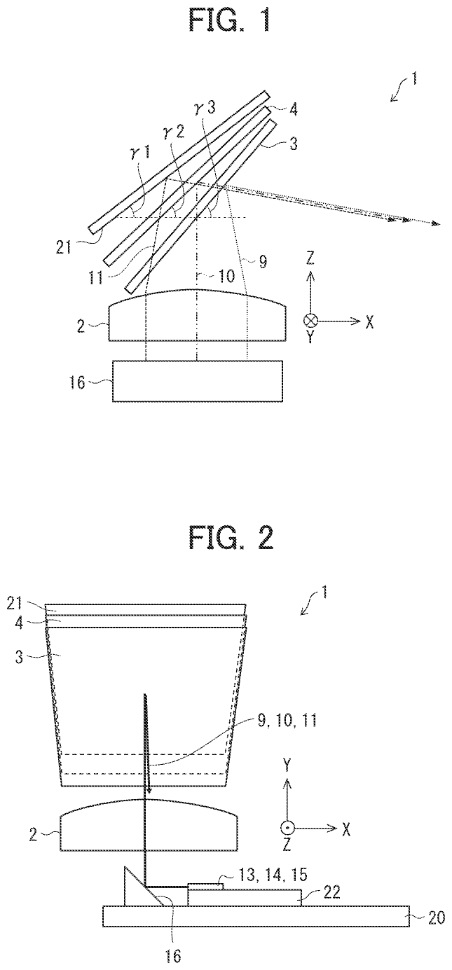

The following will describe an embodiment of the present invention in detail. FIG. 1 is a front view of a beam combining module 1 in accordance with Embodiment 1. FIG. 2 is a side view of the beam combining module 1.

The beam combining module 1 combines a first beam 9 corresponding to a first wavelength of blue light, a second beam 10 corresponding to a second wavelength of green light, and a third beam 11 corresponding to a third wavelength of red light.

The beam combining module 1 includes: a collimating lens 2 that receives the first beam 9, the second beam 10, and the third beam 11 as parallel beams and that emits the first beam 9, the second beam 10, and the third beam 11 as non-parallel beams; a first dichroic mirror 3 (first mirror) that reflects the first beam 9 emitted by the collimating lens 2; a second dichroic mirror 4 (second mirror) that reflects the second beam 10 emitted by the collimating lens 2 in a direction parallel to the first beam 9 reflected by the first dichroic mirror 3 and in such a manner that the second beam 10 emitted by the collimating lens 2 spatially overlaps the first beam 9 reflected by the first dichroic mirror 3; and a mirror 21 (third mirror) that reflects the third beam 11 emitted by the collimating lens 2 in a direction parallel to the first beam 9 reflected by the first dichroic mirror 3 and in such a manner that the third beam 11 emitted by the collimating lens 2 spatially overlaps the first beam 9 reflected by the first dichroic mirror 3.

The first dichroic mirror 3 reflects the first beam 9 and transmits the second beam 10 and the third beam 11. The second dichroic mirror 4 reflects the second beam 10 and transmits the third beam 11.

The first dichroic mirror 3, the second dichroic mirror 4, and the mirror 21 are separated by intervening free-space regions from each other and positioned non-parallel to each other.

The beam combining module 1 further includes: a first light source 13 that emits the first beam 9; a second light source 14 that emits the second beam 10; a third light source 15 that emits the third beam 11; and a reflector 16 that reflects the first beam 9 emitted by the first light source 13, the second beam 10 emitted by the second light source 14, and the third beam 11 emitted by the third light source 15 in the direction of the collimating lens 2.

The first light source 13, the second light source 14, and the third light source 15 are laser diode sources and mounted onto a submount 22. The reflector 16 and the submount 22 are disposed on a base 20.

The first beam 9, the second beam 10, and the third beam 11 of different wavelengths, which come from the first light source 13, the second light source 14, and the third light source 15, are reflected by the reflector 16 before incidence to the collimating lens 2. After transmitting through the collimating lens 2, the first beam 9, the second beam 10, and the third beam 11 from the first light source 13, the second light source 14, and the third light source 15 are collimated and rendered non-parallel to each other.

Thereafter, the first beam 9, the second beam 10, and the third beam 11 are reflected by the first dichroic mirror 3, the second dichroic mirror 4, and the mirror 21. After the reflection, the first beam 9, the second beam 10, and the third beam 11 are directed to be parallel. In addition, the first dichroic mirror 3, the second dichroic mirror 4, and the mirror 21 are positioned so that the centers of the reflected, first, second, and third beams 9, 10, 11 spatially coincide.

In the present embodiment, the first dichroic mirror 3, the second dichroic mirror 4, and the mirror 21 are separate optical elements.

The reflection by the first dichroic mirror 3, the second dichroic mirror 4, and the mirror 21 may occur at the front surface thereof, at the rear surface thereof, or at a layer embedded in these elements as shown in FIG. 1.

The combination of the first to third beams 9 to 11 shown in the figure shows an example of red, green, and blue laser diode beams. It would be however appreciated that these beams may be used in any permutation including laser diode beams of other colors.

Additional dichroic mirror elements enable combining more than three beams of different wavelengths in a similar manner.

According to the present embodiment, the provision of the single collimating lens 2 enables reducing the size of the beam combining module 1. The collimating lens 2 is disposed between the first to third light sources 13 to 15 and the first dichroic mirror 3, the second dichroic mirror 4, and the mirror 21. The first to third beams 9 to 11 collimated by the collimating lens 2 are rendered non-parallel to each other. To render these first to third beams 9 to 11 parallel, unlike the conventional beam combining module, the first dichroic mirror 3, the second dichroic mirror 4, and the mirror 21 must be non-parallel.

The present embodiment provides a structure, including the first dichroic mirror 3, the second dichroic mirror 4, the mirror 21, and the first to third light sources 13 to 15, that enables the formation of a combined beam using the single collimating lens 2.

In the present embodiment, the first to third light sources 13 to 15 need to be positioned and adjusted very carefully because generally, moving or rotating the collimating lens 2 to correct the collimation or traveling direction of a beam will inevitably result in a correction of the collimation or traveling direction of another beam. To simultaneously control the output directions and positions of N beams, generally, the positions of at least N−1 light sources need to be precisely controlled provided that the location and/or direction of the collimating lens 2 have already been adjusted. In the conventional beam combining module, the precise control of the collimation and traveling direction of each beam is done by moving individual collimating lenses.

The collimated, non-parallel, first to third beams 9 to 11 are produced by disposing the first to third light sources 13 to 15 in the focal plane of the single collimating lens 2. It would be convenient in mounting and wiring the first to third light sources 13 to 15 if the first to third light sources 13 to 15 are directed to be parallel to the base 20 to which the submount 22 is attached. Then, the first to third beams 9 to 11 from the first to third light sources 13 to 15 need to be reflected by the reflector 16 including an angled mirror in order to provide a space for adapting the spread, first to third beams 9 to 11 to the focal plane of the collimating lens 2.

The first to third light sources 13 to 15 are preferably positioned in such a manner that the effective, first to third light sources 13 to 15 as viewed from the collimating lens 2 are arranged along a straight line. If this straight line along which the effective, first to third light sources 13 to 15 are arranged passes through the optical axis of the collimating lens 2, it is possible to adjust the tilts of the first and second dichroic mirrors 3, 4 and the mirror 21 only in one plane (XZ plane shown in FIG. 1). The angle γ1 of the mirror 21, the angle γ2 of the second dichroic mirror 4, and the angle γ3 of the first dichroic mirror 3 are carefully adjusted to render the reflected, first to third beams 9 to 11 parallel.

Note that the present embodiment has so far discussed an example where three mirror are used: namely, the first dichroic mirror 3, the second dichroic mirror 4, and the mirror 21. The present invention is not at all limited to this example. Alternatively, the beam combining module may include four or more mirrors. The same description applies to the embodiments given below.

### Embodiment 2

The following will describe another embodiment of the present invention. Note that for convenience of description, members of the present embodiment that have the same function as members of the preceding embodiment are indicated by the same or similar reference numerals, and description thereof is not repeated.

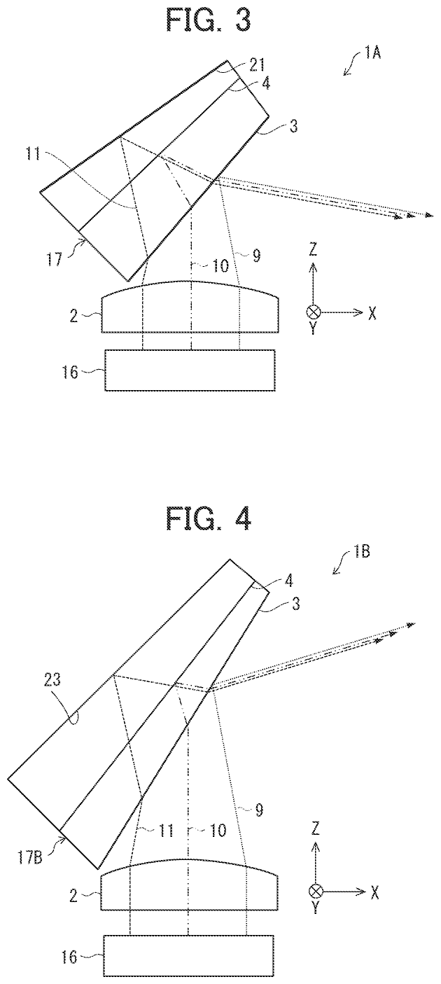

FIG. 3 is a front view of a beam combining module 1A in accordance with Embodiment 2. Embodiment 2 differs from Embodiment 1 in that the beam combining module 1A includes a dielectric block 17, that the second dichroic mirror 4 is embedded in the dielectric block 17, that the first dichroic mirror 3 is formed on a surface on the collimating lens 2 side of the dielectric block 17, and that the mirror 21 is formed on a surface of the dielectric block 17 opposite the collimating lens 2.

The dielectric block 17 needs to be disposed so as to reflect the first to third beams 9 to 11 in such directions that the first to third beams 9 to 11 travel parallel to, and spatially overlap, each other, by taking into account the refraction of light upon entry and exit.

### Embodiment 3

FIG. 4 is a front view of a beam combining module 1B in accordance with Embodiment 3. Members of the present embodiment that are similar to those described earlier are indicated by similar reference numerals, and description thereof is not repeated.

Embodiment 3 differs from Embodiment 2 in that the beam combining module 1B includes a dielectric block 17B and that the third beam 11, instead of being reflected by the mirror 21, undergoes total internal reflection (TIR) at an interface 23 of the dielectric block 17B opposite the collimating lens 2.

### Embodiment 4

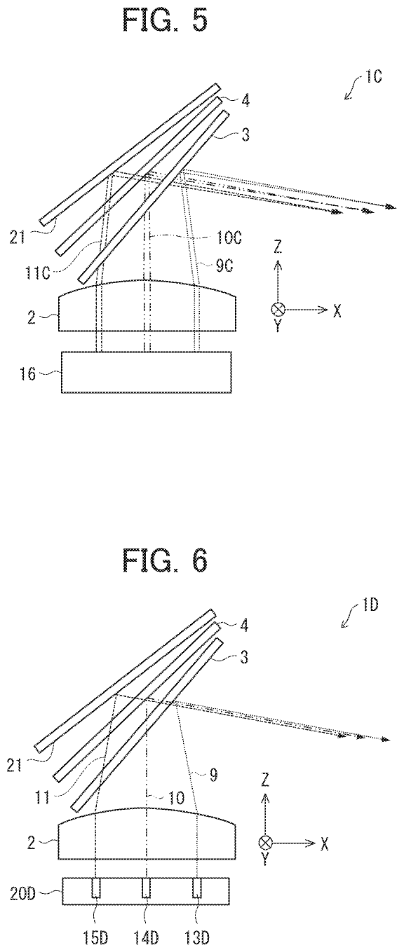

FIG. 5 is a front view of a beam combining module 1C in accordance with Embodiment 4. Members of the present embodiment that are similar to those described earlier are indicated by similar reference numerals, and description thereof is not repeated.

Embodiment 4 differs from Embodiment 1 that each light source emits a beam from a plurality of waveguides. The first light source 13 has a plurality of waveguides. The second light source 14 has another plurality of waveguides. The third light source 15 has yet another plurality of waveguides. The first light source 13 emits a first beam 9C from the plurality of waveguides. The second light source 14 emits a second beam 10C from the other plurality of waveguides. The third light source 15 emits a third beam 11C from the yet other plurality of waveguides.

This arrangement is to collimate, thereby rendering parallel, the beams that come from the different pluralities of waveguides of the light sources. There exists a small angular separation between outputs from the different pluralities of waveguides. In laser-beam scanning (LBS) applications, the angularly separated beams can be used to project different pixels in a display. The resolution can be improved in this manner. Alternatively, the angularly separated beams can be used to project the same pixels a slightly different number of times (typically, a temporary shift of a few tens of nanoseconds). The speckle noise of a displayed image is reduced in this manner, which improves luminance.

Three or more waveguides may be used in a similar configuration.

### Embodiment 5

FIG. 6 is a front view of a beam combining module 1D in accordance with Embodiment 5. Members of the present embodiment that are similar to those described earlier are indicated by similar reference numerals, and description thereof is not repeated.

Embodiment 5 differs from Embodiment 1 in that a first light source 13D, a second light source 14D, and a third light source 15D are mounted in such a manner that the optical outputs thereof can be directly incident to the collimating lens 2 without having to be changed in direction by an angled mirror.

In the present embodiment, the first light source 13D, the second light source 14D, and the third light source 15D include a laser diode semiconductor chip and are provided on a base 20D disposed facing the collimating lens 2.

### Embodiment 6

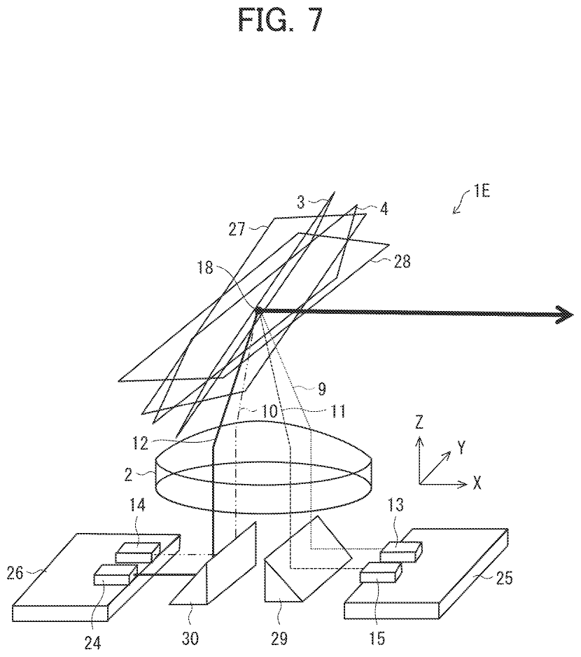

FIG. 7 is a perspective view of a beam combining module 1E in accordance with Embodiment 6. Members of the present embodiment that are similar to those described earlier are indicated by similar reference numerals, and description thereof is not repeated.

The collimating lens 2 further receives third and fourth beams 11, 12 that are parallel to the first and second beams 9, 10, emits the third beam 11 in a direction not parallel to the first and second beams 9, 10, and emits the fourth beam 12 in a direction not-parallel to the first to third beams 9, 10, 11.

The beam combining module 1E further includes: a third dichroic mirror 27 that reflects the third beam 11 emitted by the collimating lens 2 in a direction parallel to the first beam 9 reflected by the first dichroic mirror 3 and in such a manner that the third beam 11 emitted by the collimating lens 2 spatially overlaps the first beam 9 reflected by the first dichroic mirror 3; and a fourth dichroic mirror 28 that reflects the fourth beam 12 emitted by the collimating lens 2 in a direction parallel to the first beam 9 reflected by the first dichroic mirror 3 and in such a manner that the fourth beam 12 emitted by the collimating lens 2 spatially overlaps the first beam 9 reflected by the first dichroic mirror 3.

The First to fourth dichroic mirrors 3, 4, 27, 28 intersect at a common intersection point 18 and reflect the first to fourth beams 9, 10, 11, 12 at the common intersection point 18.

The beam combining module 1E further includes: a first light source 13 that emits the first beam 9 in the negative X-direction corresponding to blue light; a second light source 14 that emits the second beam 10 in the positive X-direction corresponding to green light; a third light source 15 that emits the third beam 11 in the negative X-direction corresponding to red light; a fourth light source 24 that emits the fourth beam 12 in the positive X-direction corresponding to infrared light; a reflector 29 that reflects the first beam 9 emitted by the first light source 13 and the third beam 11 emitted by the third light source 15 toward the collimating lens 2; and a reflector 30 that reflects the second beam 10 emitted by the second light source 14 and the fourth beam 12 emitted by the fourth light source 24 toward the collimating lens 2.

The first light source 13 and the third light source 15 are mounted onto a submount 25. The second light source 14 and the fourth light source 24 are mounted onto a submount 26.

In this Embodiment 6, the first to fourth light sources 13, 14, 15, 24, which are laser diodes, are not arranged along a straight line when viewed from the collimating lens 2.

A configuration is used where the first to fourth dichroic mirrors 3, 4, 27, 28 each selectively reflect one of the colors of the laser diodes. Hence, all the first to fourth beams 9, 10, 11, 12 from the first to fourth light sources 13, 14, 15, 24 are reflected by the combination of the first to fourth dichroic mirrors 3, 4, 27, 28 and propagate parallel to the propagation direction.

The first dichroic mirror 3 reflects blue light and transmits green light, red light, and infrared light. The second dichroic mirror 4 reflects green light and transmits blue light, red light, and infrared light. The third dichroic mirror 27 reflects red light and transmits blue light, green light, and infrared light. The fourth dichroic mirror 28 reflects infrared light and transmits blue light, green light, and red light.

The first to fourth dichroic mirrors 3, 4, 27, 28 intersect with each other. The first to fourth light sources 13, 14, 15, 24 are disposed so as to converge the first to fourth beams 9, 10, 11, 12 transmitted by the collimating lens 2 to the single intersection point 18. The first to fourth dichroic mirrors 3, 4, 27, 28 all intersect at this intersection point 18, so that the central axes of the reflected, first to fourth beams 9, 10, 11, 12 coincide.

FIG. 7 shows an example where the red, green, blue, and infrared beams emitted by the first to fourth light sources 13, 14, 15, 24 respectively are both spatially and directionally combined. It would be appreciated that this configuration with the same number of dichroic mirrors and laser diodes can also combine five or more beams of different wavelengths and three or less beams of different wavelengths.

A detailed description is given further of the present embodiment.

Without the straight line along which the effective light sources are arranged having to intersect with the optical axis of the collimating lens 2, it is still possible to produce parallel reflected beams. However, generally, at least one of the first to fourth dichroic mirrors 3, 4, 27, 28 need to be tilted to a plane that differs from the tilted plane of the other mirrors. In other words, the directions of the first to fourth dichroic mirrors 3, 4, 27, 28 are not all existent in a common plane.

Similarly, without the effective light sources having to be arranged along a straight line, it is possible to render all the reflected, first to third beams parallel by suitable non-common tilting of the first to fourth dichroic mirrors 3, 4, 27, 28.

The relative displacements of the first to fourth dichroic mirrors 3, 4, 27, 28 are carefully arranged so that the reflected output beams are parallel and spatially overlap as much as possible. In Embodiments 1 to 5 above, no dichroic mirrors intersect. Generally, if the effective light sources related to the collimating lens 2 are arranged along a straight line, an optimal spatial overlap can be constructed.

Even when the light sources are not arranged along a straight line, a spatial overlap can be constructed by the effective light sources related to the collimating lens 2 that intersect with the optical axis of the collimating lens 2 (provided that the collimating lens 2 is rotationally symmetric around the optical axis).

Note that the present embodiment has so far discussed an example where four mirrors, namely the first to fourth dichroic mirrors 3, 4, 27, 28, are used. The present invention is not at all limited by this example. Alternatively, five or more mirrors may be used to construct a beam combining module.

### Embodiment 7

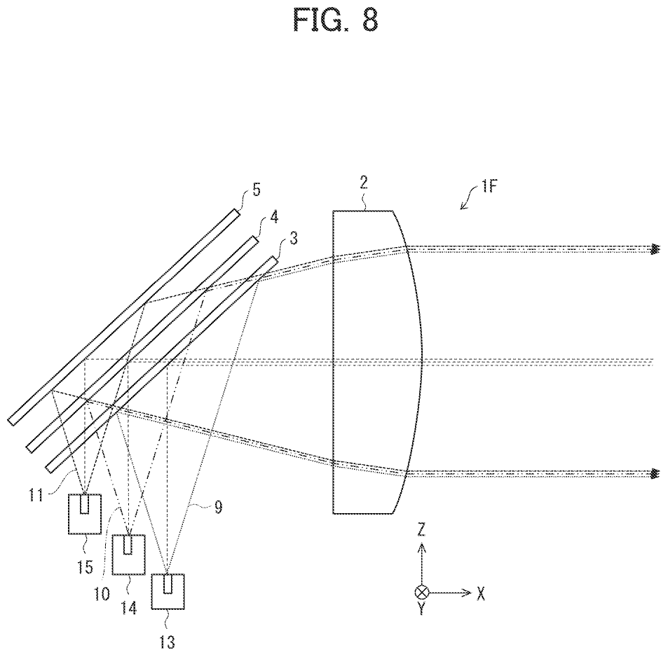

FIG. 8 is a front view of a beam combining module 1F in accordance with Embodiment 7. Members of the present embodiment that are similar to those described earlier are indicated by similar reference numerals, and description thereof is not repeated.

The beam combining module 1F combines the first beam 9 corresponding to blue light, the second beam 10 corresponding to green light, and the third beam 11 corresponding to red light.

The beam combining module 1F includes: a first dichroic mirror 3 (first mirror) that transmits the second beam 10 and the third beam 11 and that reflects the first beam 9; a second dichroic mirror 4 (second mirror) that is disposed parallel to the first dichroic mirror 3 and that reflects the second beam 10 transmitted by the first dichroic mirror 3; a third mirror 5 that is disposed parallel to the first dichroic mirror 3 and that reflects the third beam 11 transmitted by the first dichroic mirror 3 and the second dichroic mirror 4; and a collimating lens 2 that receives the first beam 9 reflected by the first dichroic mirror 3, the second beam 10 reflected by the second dichroic mirror 4, and the third beam 11 reflected by the third mirror 5 and that emits the first beam 9, the second beam 10, and the third beam 11 in such directions that the first beam 9, the second beam 10, and the third beam 11 travel parallel to, and spatially overlap, each other.

In Embodiment 7, the first to third beams 9 to 11 from the first to third light sources 13 to 15 are reflected respectively by the first and second dichroic mirrors 3, 4 and the third mirror 5 before incidence to the collimating lens 2.

In this configuration, the first and second dichroic mirrors 3, 4 and the third mirror 5 may be parallel to each other.

To render the first to third beams 9 to 11 from the first to third light sources 13 to 15 parallel by the collimating lens 2, the first to third light sources 13 to 15 must be disposed so as to allow the optical path between the sites where the first to third beams are emitted and the collimating lens 2 to have a suitable distance. Therefore, the first to third light sources 13 to 15 must be separated from each other in the Z-direction as shown in FIG. 8.

### GENERAL DESCRIPTION

The beam combining module 1, 1A, 1B, 1C, 1D, 1E of aspect 1 of the present invention is a beam combining module 1 that combines a first beam 9 corresponding to a first wavelength and a second beam 10 corresponding to a second wavelength and includes: a collimating lens 2 configured to receive the first beam 9 and the second beam 10 that are parallel to each other and to emit the first beam 9 and the second beam 10 in respective non-parallel directions; a first mirror (first dichroic mirror 3) configured to reflect the first beam 9 emitted by the collimating lens 2; and a second mirror (second dichroic mirror 4) configured to reflect the second beam 10 emitted by the collimating lens 2 in a direction parallel to the first beam 9 reflected by the first mirror (first dichroic mirror 3) and in such a manner that the second beam 10 emitted by the collimating lens 2 spatially overlaps the first beam 9 reflected by the first mirror (first dichroic mirror 3).

According to these features, the first beam incident to the collimating lens and emitted by the collimating lens is reflected by the first mirror. Then, the second beam incident to the collimating lens and emitted by the collimating lens is reflected in a direction parallel to, and in such a manner as to spatially overlap, the first beam reflected by the first mirror. Therefore, the first beam and the second beam are combined by the single common collimating lens. As a result, a beam combining module can be provided that has a reduced size in comparison with the conventional beam combining module that requires a separate collimating lens for the beam from each light source.

The beam combining module 1, 1A, 1B, 1C, 1D, 1E of aspect 2 of the present invention, in aspect 1 above, is preferably configured such that the first mirror includes a first dichroic mirror 3 that reflects the first beam 9 and that transmits the second beam 10.

According to this configuration, the first dichroic mirror reflects the first beam and transmits the second beam. Therefore, the second beam emitted by the collimating lens is, after being transmitted by the first dichroic mirror, reflected by the second mirror in a direction parallel to, and in such a manner as to spatially overlap, the first beam.

The beam combining module 1, 1A, 1C, 1D of aspect 3 of the present invention, in aspect 2 above, is preferably configured such that the collimating lens 2 further receives a third beam 11 corresponding to a third wavelength and parallel to the first and second beams 9, 10 and emits the third beam 11 in a direction not parallel to the first and second beams 9, 10, the first dichroic mirror 3 further transmits the third beam 11, the second mirror (second dichroic mirror 4) includes a second dichroic mirror 4 that reflects the second beam 10 and that transmits the third beam 11, and the beam combining module further includes a third mirror (mirror 21) configured to reflect the third beam 11 transmitted by the first and second dichroic mirrors 3, 4 in such a manner that the third beam spatially overlaps the first beam 9 reflected by the first dichroic mirror 3.

According to this configuration, the third beam emitted by the collimating lens is, after being transmitted by the first dichroic mirror and the second dichroic mirror, reflected by the third mirror in a direction spatially parallel to, and overlapping, the first beam.

The beam combining module 1, 1C, 1D of aspect 4 of the present invention, in any one of aspects 1 to 3 above, is preferably configured such that the first mirror (first dichroic mirror 3) and the second mirror (second dichroic mirror 4) are provided separated from each other by an intervening free-space region.

According to this configuration, the first mirror and the second mirror are provided separated from each other by an intervening free-space region. Therefore, the second beam emitted by the collimating lens and transmitted by the first mirror is transmitted by the free-space region, incident on the second mirror, and reflected by the second mirror in a direction parallel to, and in such a manner as to spatially overlap, the first beam.

The beam combining module 1A, 1B of aspect 5 of the present invention, in any one of aspects 1 to 3 above, is preferably configured such that the second mirror (mirror 21, second dichroic mirror 4) is formed on a surface of a dielectric block 17, 17B or embedded in the dielectric block 17, 17B.

According to this configuration, the second beam emitted by the collimating lens and transmitted by the first mirror is transmitted by the interior of the dielectric block, incident on the second mirror, and reflected by the second mirror in a direction parallel to, and in such a manner as to spatially overlap, the first beam.

In addition, it becomes possible to reduce the number of components by integrating mirror optical components.

The beam combining module 1B of aspect 6 of the present invention, in aspect 3 above, is preferably configured such that the second mirror (second dichroic mirror 4) is embedded in the dielectric block 17B, and the third beam 11 undergoes total reflection at an interface 23 of the dielectric block 17B.

According to this configuration, the third beam incident to the dielectric block undergoes total reflection at the interface of the dielectric block in a direction parallel to, and in such a manner as to spatially overlap, the first beam reflected by the first mirror.

In addition, it becomes possible to reduce the number of components by integrating mirror optical components.

The beam combining module 1, 1A, 1B, 1C, 1E of aspect 7 of the present invention, in any one of aspects 1 to 6 above, preferably further includes: a first light source 13 configured to emit the first beam 9; a second light source 14 configured to emit the second beam 10; and one or more reflectors 16, 29, 30 configured to reflect the first beam 9 emitted by the first light source 13 and the second beam 10 emitted by the second light source 14 toward the collimating lens 2.

According to this configuration, the first beam emitted by the first light source and the second beam emitted by the second light source are reflected by the reflector(s) toward the collimating lens. Therefore, a beam combining module can be provided that has a further reduced size.

The beam combining module 1, 1A, 1B, 1C, 1D, 1E of aspect 8 of the present invention, in any one of aspects 1 to 6 above, is preferably configured such that the first mirror (first dichroic mirror 3) and the second mirror (second dichroic mirror 4) are disposed not parallel to each other.

According to this configuration, since the first mirror and the second mirror are disposed not parallel to each other, the second mirror can reflect the second beam emitted by the collimating lens in a direction parallel to the first beam reflected by the first mirror and in such a manner that the second beam emitted by the collimating lens spatially overlaps the first beam reflected by the first mirror.

The beam combining module 1, 1A, 1B, 1C, 1D of aspect 9 of the present invention, in any one of aspects 1 to 8 above, is preferably configured such that the collimating lens 2 further receives the third beam 11 parallel to the first and second beams 9, 10, and the first beam 9, the second beam 10, and the third beam 11 are lined up on a common straight line before incidence to the collimating lens 2.

According to this configuration, since the effective light sources related to the collimating lens are arranged along the straight line, a spatial overlap of the first beam, the second beam, and the third beam is achieved with relative ease.

The beam combining module 1, 1A, 1B, 1C, 1D of aspect 10 of the present invention, in aspect 9 above, is preferably configured such that the straight line on which the first beam 9, the second beam 10, and the third beam 11 are lined up intersect with an optical axis of the collimating lens 2.

According to this configuration, a spatial overlap of the first beam, the second beam, and the third beam is achieved with more relative ease.

The beam combining module 1E of aspect 11 of the present invention, in any one of aspects 1 to 3 above, is preferably configured such that the first mirror (first dichroic mirror 3) and the second mirror (second dichroic mirror 4) intersect with each other.

According to this configuration, the first and second beams emitted by the collimating lens can be reflected at the intersection point of the first mirror and the second mirror in a direction parallel to, and in such a manner as to spatially overlap, each other.

The beam combining module 1E of aspect 12 of the present invention, in aspect 11 above, is preferably configured such that the collimating lens 2 further receives a third and a fourth beam 11, 12 parallel to the first and second beams 9, 10, emits the third and fourth beam 11, 12 in a direction not parallel to the first and second beams 9, 10, and emits the fourth beam 12 in a direction not parallel to the first to third beams 9 to 11, the beam combining module further includes: a third mirror (third dichroic mirror 27) configured to reflect the third beam 11 emitted by the collimating lens 2 in a direction parallel to the first beam 9 reflected by the first mirror (first dichroic mirror 3) and in such a manner that the third beam 11 emitted by the collimating lens 2 spatially overlaps the first beam 9 reflected by the first mirror (first dichroic mirror 3); and a fourth mirror (fourth dichroic mirror 28) configured to reflect the fourth beam 12 emitted by the collimating lens 2 in a direction parallel to the first beam 9 reflected by the first mirror (first dichroic mirror 3) and in such a manner that the fourth beam 12 emitted by the collimating lens 2 spatially overlaps the first beam 9 reflected by the first mirror (first dichroic mirror 3), and the first to fourth mirrors (first to fourth dichroic mirrors 3, 4, 27, 28) intersect at a common intersection point 18 and reflect the first to fourth beams 9 to 12 at the common intersection point 18.

According to this configuration, the four beams, namely the first beam, the second beam, the third beam, and the fourth beam, can be reflected in a direction parallel to each other for combination.

The beam combining module 1C of aspect 13 of the present invention is preferably configured such that the first light source 13 includes a plurality of waveguides, and the first beam includes a plurality of angularly separated waveguide beams emitted by the plurality of waveguides.

According to this configuration, the beams coming from the different pluralities of waveguides of the light sources are configured so as to be collimated and rendered parallel. There exists a small angular separation between outputs from the different pluralities of waveguides. In laser-beam scanning (LBS) applications, the angularly separated beams can be used to project different pixels in a display. The resolution can be improved in this manner. Alternatively, the angularly separated beams can be used to project the same pixels a slightly different number of times (typically, a temporary shift of a few tens of nanoseconds). The speckle noise of a displayed image is reduced in this manner, which improves luminance.

The beam combining module 1F of aspect 14 of the present invention is a beam combining module 1F that combines a first beam 9 corresponding to a first wavelength and a second beam 10 corresponding to a second wavelength, the beam combining module including: a first mirror (first dichroic mirror 3) configured to transmit the second beam 10 and to reflect the first beam 9; a second mirror (second dichroic mirror 4) disposed parallel to the first mirror (first dichroic mirror 3) and configured to reflect the second beam 10 transmitted by the first mirror (first dichroic mirror 3); and a collimating lens 2 configured to receive the first beam 9 reflected by the first mirror (first dichroic mirror 3) and the second beam 10 reflected by the second mirror (second dichroic mirror 4) and to emit the first beam 9 and the second beam 10 in such directions that the first beam 9 and the second beam 10 travel parallel to, and spatially overlap, each other.

According to these features, the first beam reflected by the first mirror and the second beam transmitted by the first mirror and reflected by the second mirror enter the collimating lens and exit the collimating lens in a direction parallel to, and in such a manner as to spatially overlap, each other.

Therefore, the first beam and the second beam are combined by the single common collimating lens. As a result, a beam combining module can be provided that has a reduced size in comparison with the conventional beam combining module that requires a separate collimating lens for the beam from each light source.

A beam scanning projector system of aspect 15 of the present invention includes the beam combining module of any one of aspects 1 to 14 of the present invention.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A beam combining module that combines a first beam corresponding to a first wavelength and a second beam corresponding to a second wavelength, the beam combining module comprising:
a collimating lens configured to receive the first beam and the second beam that are parallel to each other and to emit the first beam and the second beam in respective non-parallel directions;
a first mirror configured to reflect the first beam emitted by the collimating lens; and
a second mirror configured to reflect the second beam emitted by the collimating lens in a direction parallel to the first beam reflected by the first mirror and in such a manner that the second beam emitted by the collimating lens spatially overlaps the first beam reflected by the first mirror.

2. The beam combining module according to claim 1, wherein the first mirror includes a first dichroic mirror that reflects the first beam and that transmits the second beam.

3. The beam combining module according to claim 2, wherein
the collimating lens further receives a third beam corresponding to a third wavelength and parallel to the first and second beams and emits the third beam in a direction not parallel to the first and second beams,
the first dichroic mirror further transmits the third beam,
the second mirror includes a second dichroic mirror that reflects the second beam and that transmits the third beam, and
the beam combining module further comprises a third mirror configured to reflect the third beam transmitted by the first and second dichroic mirrors in such a manner that the third beam spatially overlaps the first beam reflected by the first dichroic mirror.

4. The beam combining module according to claim 1, wherein the first mirror and the second mirror are provided separated from each other by an intervening free-space region.

5. The beam combining module according to claim 1, wherein the second mirror is formed on a surface of a dielectric block or embedded in the dielectric block.

6. The beam combining module according to claim 3, wherein
the second mirror is embedded in a dielectric block, and
the third beam undergoes total reflection at an interface of the dielectric block.

7. The beam combining module according to claim 1, further comprising:
a first light source configured to emit the first beam;
a second light source configured to emit the second beam; and
one or more reflectors configured to reflect the first beam emitted by the first light source and the second beam emitted by the second light source toward the collimating lens.

8. The beam combining module according to claim 1, wherein the first mirror and the second mirror are disposed not parallel to each other.

9. The beam combining module according to claim 1, wherein
the collimating lens further receives the third beam parallel to the first and second beams, and
the first beam, the second beam, and the third beam are lined up on a common straight line before incidence to the collimating lens.

10. The beam combining module according to claim 9, wherein the straight line on which the first beam, the second beam, and the third beam are lined up intersect with an optical axis of the collimating lens.

11. The beam combining module according to claim 1, wherein the first mirror and the second mirror intersect with each other.

12. The beam combining module according to claim 11, wherein
the collimating lens further receives a third and a fourth beam parallel to the first and second beams, emits the third beam in a direction not parallel to the first and second beams, and emits the fourth beam in a direction not parallel to the first to third beams,
the beam combining module further comprises:
a third mirror configured to reflect the third beam emitted by the collimating lens in a direction parallel to the first beam reflected by the first mirror and in such a manner that the third beam emitted by the collimating lens spatially overlaps the first beam reflected by the first mirror; and
a fourth mirror configured to reflect the fourth beam emitted by the collimating lens in a direction parallel to the first beam reflected by the first mirror and in such a manner that the fourth beam emitted by the collimating lens spatially overlaps the first beam reflected by the first mirror, and
the first to fourth mirrors intersect at a common intersection point and reflect the first to fourth beams at the common intersection point.

13. The beam combining module according to claim 7, wherein
the first light source includes a plurality of waveguides, and
the first beam includes a plurality of angularly separated waveguide beams emitted by the plurality of waveguides.

14. A beam combining module that combines a first beam corresponding to a first wavelength and a second beam corresponding to a second wavelength, the beam combining module comprising:
a first mirror configured to transmit the second beam and to reflect the first beam;
a second mirror disposed parallel to the first mirror and configured to reflect the second beam transmitted by the first mirror; and
a collimating lens configured to receive the first beam reflected by the first mirror and the second beam reflected by the second mirror and to emit the first beam and the second beam in such directions that the first beam and the second beam travel parallel to, and spatially overlap, each other.

15. A beam scanning projector system comprising the beam combining module according to claim 1.
